(19) United States
(12) Patent Application Publication
(10) Pub. No.: US 2009/0029896 A1
(43) Pub. Date: Jan. 29, 2009

(54) Fast Release Granules

(76) Inventor: Andrew Paul Chapple, Bebington, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/224,246

(22) PCT Filed: Feb. 2, 2007
(86) PCT No.: PCT/EP2007/000990

§ 371 Date: Aug. 21, 2008

(30) Foreign Application Priority Data
Feb. 24, 2006 (EP) 06250978.1

(51) Int. Cl. C09K 15/02; C09K 15/06; B32B 5/16; C11D 3/20; C11D 1/72

(52) U.S. Cl. 510/276; 252/397; 252/400.3; 428/402; 510/106

(57) ABSTRACT

The present invention provides a granule that releases antioxidants rapidly.

### FIELD OF INVENTION

The present invention relates to granule conferring improved delivery of antioxidants to wash liquor.

### BACKGROUND OF INVENTION

Rapid delivery of adjuncts to a wash medium is important because it is necessary to have active adjuncts present in the wash liquor for the maximum time so that they perform in the most efficacious manner.

EP 570237, GB 1570128, GB 2348436, GB 2095274 and GB 2097419 disclose granules comprising bentonite and non-ionic surfactant. The granules may optionally comprise antioxidants.

GB 1557568 discloses a granular laundry composition comprising an agglomerate of (a) from 1 to 50% by weight of the agglomerate of a quaternary ammonium surface active agent, and (b) from 10 to 90% by weight of the agglomerate of an organic acid precursor as activator for a persalt bleaching agent. It may also be desirable, especially if nonionic surface-active agents are mixed in prior to the spray-drying operation, to incorporate from 0.01% to 10%, expressed by reference to the non-ionic surfactant, of an antioxidant. Further optional ingredient is an ion-exchangeable smectite clay, such as Bentonite.

### SUMMARY OF INVENTION

The present invention provides a granule that releases an antioxidant rapidly into a wash medium.

In one aspect of the present invention there is provided a granule comprising:

(i) a bentonite particle;

(ii) nonionic surfactant; and,

(iii) an antioxidant, wherein the antioxidant is dissolved in the non-ionic surfactant forming an antioxidant/non-ionic solution,

wherein the weight ratio of antioxidant to non-ionic is at least 5:100, and the weight ratio of antioxidant/non-ionic solution to bentonite is in the range from 10:100 to 1:1, preferably 10:100 to 50:100, more preferably 20:100 to 40:100.

The maximum weight ratio of antioxidant to non-ionic is determined by the solubility of the antioxidant in the non-ionic; in any event the preferred maximum weight ratio of antioxidant to non-ionic is 1:1.

In another aspect of the present invention there is provided a method of preparing a clay granule comprising the steps of:

(i) dissolving the antioxidant in a non-ionic surfactant, and mixing with particulate bentonite; and,

(ii) granulating,

wherein the weight ratio of antioxidant to non-ionic is at least 5:100 and the weight ratio of antioxidant/non-ionic solution to bentonite is in the range from 10:100 to 1:1.

In a further aspect of the present invention there is provided a method of treating a textile with the antioxidant granules of the present invention in an aqueous medium, followed by rinsing and drying the textile.

Treatment is preferably carried out in the domestic context, at temperature between 10 to 60° C., preferably 15 to 40° C.

### DETAILED DESCRIPTION OF THE INVENTION

### The Granule

The granule is preferably a sieve fraction in the range 180 to 1400 microns. The granule is preferably used in a laundry detergent powder formulation in the range from 0.1 to 5 wt %.

### Bentonite

Bentonite is a widely used clay and is commercially available as a fine powder. A granular form may also be used.

### Antioxidant

Anti-oxidants are substances as described in Kirk-Othmers (Vol 3, pg 424) and in Uhlmans Encyclopedia (Vol 3, pg 91) and CRC Press Oxidation Inhibition in Organic Materials Vols I and II, Eds. Jan Pospisil and Peter P. Klemchuk: ISBN 0-8493-4767-X and 0-8493-4768-8.

One class of anti-oxidants suitable for use in the present invention is alkylated phenols having the general formula:

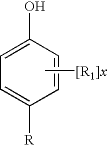

wherein R is C1-C22 linear or branched alkyl, preferably methyl or branched C3-C6 alkyl; C3-C6 alkoxy, preferably methoxy; R1 is a C3-C6 branched alkyl, preferably tert-butyl; x is 1 or 2. Hindered phenolic compounds are preferred as antioxidant.

Another class of anti-oxidants suitable for use in the present invention is a benzofuran or benzopyran derivative having the formula:

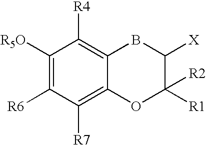

wherein R1 and R2 are each independently alkyl or R1 and R2 can be taken together to form a C5-C6 cyclic hydrocarbyl moiety; B is absent or CH2; R4 is C1-C6 alkyl; R5 is hydrogen or —C(O)R3 wherein R3 is hydrogen or C1-C19 alkyl; R6 is C1-C6 alkyl; R7 is hydrogen or C1-C6 alkyl; X is —CH2OH, or —CH2A wherein A is a nitrogen comprising unit, phenyl, or substituted phenyl. Preferred nitrogen comprising A units include amino, pyrrolidino, piperidino, morpholino, piperazino, and mixtures thereof.

Other suitable antioxidants are found as follows. A derivative of α-tocopherol, beta-tocopherol, gamma-tocopherol, delta-tocopherol, and alkyl esters of gallic acid, especially octyl gallate and dodecyl gallate.

Another example of suitable antioxidants are the class of hindered amine light stabilisers (HALS), particularly those based 2,2,6,6-tetramethylpipiridines.

Preferred anti-oxidants are phenols, in particular 2,6-di-tert-butylphenol, 2,6-di-tert-butyl-4-methylphenol, and mixtures of 2 and 3-tert-butyl-4-methoxyphenol. A preferred antioxidant is 4,4′-isopropylidenebis(2,6-dimethylphenol).

Mixtures of antioxidants may be use and in particular mixtures that have synergic antioxidant.

### Non-Ionic Surfactant

The non-ionic surfactant may be selected from alcohol ethoxylates, R—(OCH₂CH₂)ₙOH, where R is an alkyl chain typically C₁₀ to C₁₈ and n is 1 to 20, preferably 3 to 9, most preferred n=7. Preferred nonionic surfactants such as C₁₂-C₁₈ alkyl ethoxylates (“AE”) including the so-called narrow peaked alkyl ethoxylates.

In a further preferred aspect, the non-ionic is preferably selected from materials having an alkyl chain length in the range C10 to C18, with an ethoxylate number in the range 1 to 10, preferably 3 to 7.

### Binder

The non-ionic/antioxidant may serve as a binder with out the need for other binders to be present. It is however preferred that a binder other than the non-ionic surfactant is used. Preferably, the other binder is present between 0 and 20 wt % of the total granule weight, preferably 3 to 15% and more preferably 5 to 10%.

The binder may be water but may be any other suitable material that serves to hold individual particles of bentonite/non-ionic together. Polycarboxylate binders are preferred; commercial examples of such are available from BASF, for example: Sokalan CP 10, Sokalan CP 45, Sokalan CP 5, Sokalan CP 7, Sokalan CP 9, Sokalan PA 15, Sokalan PA 20, Sokalan PA 40.

### Experimental

### Preparation of Granules: Anti-Oxidant/Bentonite Granules

1) Bentonite/2,6-di-tert-butyl-4 methylphenol

1.0 g of 2,6-di-tert-butyl-4-methylphenol was dissolved in 9.0 g coco7EO nonionic to obtain a anti-oxidant/nonionic solution. 10.0 g of bentonite powder (Optigel CK—Sud Chemie) was then mixed thoroughly in a pestle and mortar with 2.5 g of the anti-oxidant/nonionic solution, forming a free-flowing powder. The resulting free-flowing powder was then granulated with 2.7 g of Sokalan CP5 (BASF) (40%). The granules were then dried in an oven at 80° C. and finally sieved to provide a granulate sized in the range 180 and 1000 microns.

2) Bentonite/4,4′-isopropylidenebis(2,6-dimethylphenol)

1.0 g of 4,4′-isopropylidenebis(2,6-dimethylphenol) was dissolved in 9.0 g coco7EO nonionic. 10.0 g of bentonite powder (Optigel CK—Sud Chemie) was then mixed thoroughly in a pestle and mortar with 2.5 g of the anti-oxidant/nonionic solution, forming a free-flowing powder.

The resulting free-flowing powder was then granulated with 2.7 g of Sokalan CP5 (BASF) (40%). The granules were then dried in an oven at 80° C. and finally sieved to provide a granulate sized in the range 180 and 1000 microns.

3) Granule, prepared by high shear mixer granulation, containing 11.6% 2,6-di-tert-butyl-4 methylphenol, 54.3% zeolite, 11.6% ascorbic acid and 22.5% PEG6000, where the 2,6-di-tert-butyl-4 methylphenol was added as a milled powder.

4) Granule, prepared by high shear mixer granulation, containing 12.7% 2,6-di-tert-butyl-4 methylphenol, 59.2% sodium sulphate, 12.7% ascorbic acid and 15.4% PEG6000, where the 2,6-di-tert-butyl-4 methylphenol was added as a milled powder.

5) Granule, prepared by high shear mixer granulation, containing 12.0% 2,6-di-tert-butyl-4 methylphenol, 57.3% zeolite, 12.0 ascorbic acid and 18.7% Genapol T-500 (Clariant), where the 2,6-di-tert-butyl-4 methylphenol was added as a melt.

6) Granule, prepared by high shear mixer granulation, containing 12.6% 4,4′-isopropylidenebis(2,6-dimethylphenol), 84.9% sodium sulphate and 2.6% Sokalan CP13S (BASF), where the 4,4′-isopropylidenebis(2,6-dimethylphenol) was added as a milled powder.

### Rate of Release Method

4 g of detergent powder (in this instance Brazilian OMO MA) was dissolved in 1 litre of demineralized water at room temperature and stirred (magnetic stirrer) for 20 minutes in order for complete dissolution.

After the dissolution period, 0.1 g of the antioxidant containing granules, sieve fraction 180 to 1000 microns, were added to the solution with constant stirring.

A small sample of the solution was taken after 5 minutes using a 2 ml syringe. This sample was immediately filtered through a Whatman Puradisc (1.0 micromol polyethersulfone membrane) filter. The filtered sample was analysed by HPLC to determine the percentage of antioxidant released.

The amount of anti-oxidant released into the wash solution after 5 minutes, for each of the examples, is shown in the following table.

| | % Anti-oxidant |
|---|---|
| | Released after 5 |
| Example | minutes |
| 1 | 100 |
| 2 | 86 |
| Comparative 3 | 12 |
| Comparative 4 | 12 |
| Comparative 5 | 36 |
| Comparative 6 | 28 |

1. A granule comprising:
(i) a bentonite particle;
(ii) non-ionic surfactant; and,
(iii) an antioxidant, wherein the antioxidant is dissolved in the non-ionic surfactant forming an antioxidant non-ionic solution,
wherein the weight ratio of antioxidant to non-ionic is at least 5:100 and the weight ratio of antioxidant/non-ionic solution to bentonite is in the range from 10:100 to 1:1.

2. A granule according to claim 1, wherein the non-ionic is selected from materials having an alkyl chain length in the range C10 to C18, with an ethoxylate number in the range 1 to 10.

3. A granule according to claim 1, wherein the antioxidant is selected from the group consisting of: 2,6-di-tert-butylphenol, 2,6-di-tert-butyl-4-methylphenol, and 4,4′-isopropylidenebis(2,6-dimethylphenol).

4. A granule according to claim 1, wherein the granule comprises a binder other than a non-ionic surfactant binder in the range between 0 and 20 wt % of the total granule weight.

5. A granule according to claim 1, wherein the antioxidant granules are a sieve fraction in the range 180 to 1400 microns.

6. A laundry detergent powder formulation comprising the antioxidant granule, as defined in claim 1, in the range 0.1 to 5 wt %.

7. A method of preparing a clay granule comprising the steps of:
(i) dissolving the antioxidant in a non-ionic surfactant, and mixing with particulate bentonite; and,
(ii) granulating,
wherein the weight ratio of antioxidant to non-ionic is at least 5:100 and the weight ratio of antioxidant/non-ionic solution to bentonite is in the range from 10:100 to 1:1.
